(19) United States
(12) Patent Application Publication
(10) Pub. No.: US 2024/0034824 A1
(43) Pub. Date: Feb. 1, 2024

(54) PHOTOCURABLE RESIN COMPOSITION AND METHOD FOR PRODUCING THREE-DIMENSIONAL OBJECT

(71) Applicant: CANON KABUSHIKI KAISHA, Tokyo (JP)

(72) Inventor: KAZUHO SAEKI, Kanagawa (JP)

(21) Appl. No.: 18/353,511

(22) Filed: Jul. 17, 2023

(30) Foreign Application Priority Data
Jul. 20, 2022 (JP) 2022-115656
Apr. 21, 2023 (JP) 2023-069819

(51) Int. Cl. C08F 226/06; C08K 5/098; C08K 5/5419; C08K 5/5397; C08J 7/18

(52) U.S. Cl. CPC C08F 226/06; C08K 5/098; C08K 5/5419; C08K 5/5397; C08J 7/18; C08K 2201/005

(57) ABSTRACT

A photocurable resin composition containing a radically polymerizable component (A), a metallic soap (B), and a curing agent (C), wherein the component (A) contains a polyfunctional radically polymerizable compound (A-1) and a monofunctional radically polymerizable compound (A-2), wherein a difference in HSP value between the component (A) and the component (B) is 0 MPa^{1/2} or more and 8.0 MPa^{1/2} or less.

### BACKGROUND

### Field of the Disclosure

The present disclosure relates to a photocurable resin composition for three-dimensional modeling and a method for producing a three-dimensional object using the photocurable resin composition.

### Description of the Related Art

A three-dimensional optical modeling method (hereinafter referred to as an optical modeling method) is known in which the step of selectively irradiating a photocurable resin composition with light on the basis of a three-dimensional shape of a three-dimensional model to form a cured resin layer is repeated to produce a three-dimensional object composed of the cured resin layers integrally stacked.

The optical modeling method has been applied to the modeling of a prototype for shape verification (rapid prototyping) or to the modeling of a working model or the modeling of a mold for functional verification (rapid tooling). Furthermore, in recent years, the optical modeling method has begun to be also applied to the modeling of an actual product (rapid manufacturing).

Under such circumstances, demands for photocurable resin compositions have become more sophisticated. As an example of the demands, there is a need for a photocurable resin composition for producing a three-dimensional object with a low friction coefficient and high wear resistance (the low friction characteristics and the high wear resistance may be hereinafter collectively referred to as good sliding characteristics) comparable to those of general-purpose engineering plastics. On the other hand, the optical modeling method includes sequentially forming and stacking cured resin layers and may therefore take a long time for modeling depending on the size of the article, and a photocurable resin composition before curing is often stored in a liquid state for a long time. Thus, a liquid photocurable resin composition for optical modeling is simultaneously required not to cause separation or deterioration for extended periods (hereinafter sometimes referred to as storage stability).

Japanese Patent Laid-Open No. 2018-141142 discloses, as a photocurable resin composition with antifriction properties, a photocurable resin composition containing a compound with two to eight (meth)acryloyl groups, a filler composed of fine silicone particles and fine silica particles, a (meth)acrylate with a phosphate group, a polyethylene wax, and a photopolymerization initiator. Japanese Patent Laid-Open No. 2004-83822 discloses, as a resin composition to be applied to a sealing member of a sliding portion, a photocurable resin composition containing an organopolysiloxane with a radiation-curable reactive group in the molecule thereof, a spherical silicone filler, sprayed silica, and a polymerization initiator.

### SUMMARY

The present disclosure provides a photocurable resin composition that contains a radically polymerizable component (A) and a curing agent (C), wherein the component (A) contains a polyfunctional radically polymerizable compound (A-1) and a monofunctional radically polymerizable compound (A-2), wherein the photocurable resin composition further contains a metallic soap (B), and a difference in HSP value between the component (A) and the component (B) is 0 MPa^{1/2} or more and 8.0 MPa^{1/2} or less.

A cured product according to the present disclosure is produced by curing the photocurable resin composition.

A method for producing a three-dimensional object according to the present disclosure is a method for producing a three-dimensional object by an optical modeling method, including the steps of: providing a photocurable resin composition in a layer form; and applying light energy to the photocurable resin composition in the layer form based on slice data of a modeling model to cure the photocurable resin composition and form a modeling product, wherein the photocurable resin composition is the photocurable resin composition described above.

Further features of the present disclosure will become apparent from the following description of exemplary embodiments with reference to the attached drawing.

### BRIEF DESCRIPTION OF THE DRAWINGS

FIGURE is a schematic view of an example of an optical modeling apparatus.

### DESCRIPTION OF THE EMBODIMENTS

In the photocurable resin compositions disclosed in Japanese Patent Laid-Open No. 2018-141142 and PCT Japanese Translation Patent Publication No. 2004-83822, there is a concern that fine silicone particles and fine silica particles added to impart sliding characteristics are separated in a liquid during long-term storage and affect the characteristics of the cured product. Thus, there has been no photocurable resin composition that can be cured to have good sliding characteristics, has high storage stability, and is suitable for three-dimensional modeling.

In view of such circumstances, the present disclosure provides a photocurable resin composition that can form a three-dimensional object with good sliding characteristics and has high storage stability.

Embodiments of the present disclosure are described below. These embodiments are only some embodiments of the present disclosure, and the present disclosure is not limited to these embodiments.

A photocurable resin composition according to the present embodiment contains a radically polymerizable component (A), a metallic soap (B), and a curing agent (C), wherein the radically polymerizable component (A) contains a polyfunctional radically polymerizable compound (A-1) and a monofunctional radically polymerizable compound (A-2). Each of the components is described below.

### <Component (A-1): Polyfunctional Radically Polymerizable Compound>

The polyfunctional radically polymerizable compound (A-1) contained in the photocurable resin composition for three-dimensional modeling according to the present embodiment (also referred to simply as a “curable resin composition” or a “resin composition”) is a compound with two or more radically polymerizable functional groups in the molecule thereof. Examples of the radically polymerizable functional groups include ethylenically unsaturated groups. Examples of the ethylenically unsaturated groups include a (meth)acryloyl group, a vinyl group, an allyl group, a (meth)acrylamide group, and a maleimide group. Examples of the polyfunctional radically polymerizable compound include (meth)acrylate compounds, (meth)acrylate compounds with a vinyl ether group, isocyanurate compounds with a (meth)acryloyl group, (meth)acrylamide compounds, urethane (meth)acrylate compounds, maleimide compounds, vinyl ether compounds, and aromatic vinyl compounds. Among these, (meth)acrylate compounds and urethane (meth)acrylate compounds are easily available and highly curable.

Examples of the (meth)acrylate compounds include ethylene glycol di(meth)acrylate, diethylene glycol di(meth)acrylate, triethylene glycol di(meth)acrylate, tetraethylene glycol di(meth)acrylate, nonaethylene glycol di(meth)acrylate, 1,3-butylene glycol di(meth)acrylate, 1,4-butanediol di(meth)acrylate, dimethylol tricyclodecane di(meth)acrylate, trimethylolpropane tri(meth)acrylate, neopentyl glycol di(meth)acrylate, 1,6-hexamethylene di(meth)acrylate, hydroxy pivalate neopentyl glycol di(meth)acrylate, pentaerythritol tri(meth)acrylate, pentaerythritol tetra(meth)acrylate, ditrimethylolpropane tetraacrylate, dipentaerythritol tetra(meth)acrylate, dipentaerythritol penta(meth)acrylate, dipentaerythritol hexa(meth)acrylate, di(meth)acrylate of an ε-caprolactone adduct of hydroxypivalic acid neopentyl glycol (for example, KAYARAD HX-220 and HX-620 manufactured by Nippon Kayaku Co., Ltd.), di(meth)acrylate of an EO adduct of bisphenol A, (meth)acrylate with a fluorine atom, (meth)acrylate with a siloxane structure, polycarbonatediol di(meth)acrylate, polyester di(meth)acrylate, and poly(ethylene glycol) di(meth)acrylate.

Examples of the (meth)acrylate compounds with a vinyl ether group include 2-vinyloxyethyl (meth)acrylate, 4-vinyloxybutyl (meth)acrylate, 4-vinyloxycyclohexyl (meth)acrylate, 2-(vinyloxyethoxy)ethyl (meth)acrylate, and 2-(vinyloxyethoxyethoxyethoxy)ethyl (meth)acrylate.

Examples of the isocyanurate compounds with a (meth)acryloyl group include tri(acryloyloxyethyl) isocyanurate, tri(methacryloyloxyethyl) isocyanurate, and ε-caprolactone-modified tris-(2-acryloxyethyl) isocyanurate.

Examples of the (meth)acrylamide compounds include N,N-methylene bisacrylamide, N,N′-ethylene bisacrylamide, N,N′-(1,2-dihydroxyethylene) bisacrylamide, N,N′-methylene bismethacrylamide, and N,N′,N″-triacryloyl diethylene triamine.

Examples of the maleimide compounds include 4,4′-diphenyhnethane bismaleimide, m-phenylene bismaleimide, bisphenol A diphenyl ether bismaleimide, 3,3′-dimethyl-5,5′-diethyl-4,4′-diphenylmethane bismaleimide, 4-methyl-1,3-phenylene bismaleimide, and 1,6-bismaleimide-(2,2,4-trimethyl) hexane.

Examples of the vinyl ether compounds include ethylene glycol divinyl ether, diethylene glycol divinyl ether, poly(ethylene glycol) divinyl ether, propylene glycol divinyl ether, butylene glycol divinyl ether, hexanediol divinyl ether, bisphenol A alkylene oxide divinyl ether, bisphenol F alkylene oxide divinyl ether, trimethylolpropane trivinyl ether, ditrimethylolpropane tetravinyl ether, glycerin trivinyl ether, pentaerythritol tetravinyl ether, dipentaerythritol pentavinyl ether, and dipentaerythritol hexavinyl ether.

Examples of the urethane (meth)acrylate compounds include those produced by a reaction between a (meth)acrylate compound with a hydroxy group and a polyvalent isocyanate compound and those produced by a reaction between a polyol compound and a monofunctional (meth)acrylate compound with an isocyanate group. Other examples include those produced by a reaction of a (meth)acrylate compound with a hydroxy group, a polyvalent isocyanate compound, and a polyol compound. In particular, those produced by a reaction of a (meth)acrylate compound with a hydroxy group, a polyvalent isocyanate compound, and a polyol compound have high toughness.

Examples of the (meth)acrylate compound with a hydroxy group include hydroxyalkyl (meth)acrylates, such as 2-hydroxyethyl (meth)acrylate, 2-hydroxypropyl (meth)acrylate, 2-hydroxybutyl (meth)acrylate, 4-hydroxybutyl (meth)acrylate, and 6-hydroxyhexyl (meth)acrylate, 2-hydroxyethyl acryloyl phosphate, 2-(meth)acryloyloxyethyl-2-hydroxypropyl phthalate, caprolactone-modified 2-hydroxyethyl (meth)acrylate, dipropylene glycol (meth)acrylate, fatty-acid-modified glycidyl (meth)acrylate, poly(ethylene glycol) mono(meth)acrylate, poly(propylene glycol) mono(meth)acrylate, 2-hydroxy-3-(meth)acryloyl-oxypropyl (meth)acrylate, glycerin di(meth)acrylate, 2-hydroxy-3-acryloyl-oxypropyl methacrylate, pentaerythritol tri(meth)acrylate, caprolactone-modified pentaerythritol tri(meth)acrylate, ethylene-oxide-modified pentaerythritol tri(meth)acrylate, dipentaerythritol penta(meth)acrylate, caprolactone-modified dipentaerythritol penta(meth)acrylate, and ethylene-oxide-modified dipentaerythritol penta(meth)acrylate. These (meth)acrylate compounds with a hydroxy group may be used alone or in combination.

Examples of the polyvalent isocyanate compound include aromatic polyisocyanates, such as tolylene diisocyanate, diphenylmethane diisocyanate, polyphenylmethane polyisocyanate, modified diphenylmethane diisocyanate, xylylene diisocyanate, tetramethylxylylene diisocyanate, phenylene diisocyanate, and naphthalene diisocyanate; aliphatic polyisocyanates, such as pentamethylene diisocyanate, hexamethylene diisocyanate, trimethylhexamethylene diisocyanate, lysine diisocyanate, and lysine triisocyanate; and alicyclic polyisocyanates, such as hydrogenated diphenylmethane diisocyanate, hydrogenated xylylene diisocyanate, isophorone diisocyanate, norbornene diisocyanate, and 1,3-bis(isocyanatomethyl) cyclohexane; and trimeric and multimeric compounds, allophanate polyisocyanates, biuret polyisocyanates, and water-dispersible polyisocyanates of these polyisocyanates. These polyvalent isocyanate compounds may be used alone or in combination.

Examples of the polyol compound include polyether polyols, polyester polyols, polycarbonate polyols, polyolefin polyols, polybutadiene polyols, (meth)acrylic polyols, and polysiloxane polyols. These polyol compounds may be used alone or in combination.

Examples of the polyether polyols include polyether polyols with an alkylene structure, such as poly(ethylene glycol), poly(propylene glycol), poly(tetramethylene glycol), poly(butylene glycol), and poly(hexamethylene glycol), and random or block copolymers of these poly(alkylene glycol)s.

Examples of the polyester polyols include condensation polymers of a polyhydric alcohol and a polycarboxylic acid, ring-opening polymers of a cyclic ester (lactone), and reaction products of three components of a polyhydric alcohol, a polycarboxylic acid, and a cyclic ester.

Examples of the polyhydric alcohol include ethylene glycol, diethylene glycol, propylene glycol, dipropylene glycol, trimethylene glycol, 1,4-tetramethylenediol, 1,3-tetramethylenediol, 2-methyl-1,3-trimethylenediol, 1,5-pentamethylenediol, neopentyl glycol, 1,6-hexamethylenediol, 3-methyl-1,5-pentamethylenediol, 2,4-diethyl-1,5-pentamethylenediol, glycerin, trimethylolpropane, trimethylolethane, cyclohexanediols (1,4-cyclohexanediol and the like), bisphenols (bisphenol A and the like), and sugar alcohols (xylitol, sorbitol, and the like).

Examples of the polycarboxylic acid include aliphatic dicarboxylic acids, such as malonic acid, maleic acid, fumaric acid, succinic acid, glutaric acid, adipic acid, suberic acid, azelaic acid, sebacic acid, and dodecanedioic acid, alicyclic dicarboxylic acids, such as 1,4-cyclohexanedicarboxylic acid, and aromatic dicarboxylic acids, such as terephthalic acid, isophthalic acid, orthophthalic acid, 2,6-naphthalenedicarboxylic acid, para-phenylene dicarboxylic acid, and trimellitic acid.

Examples of the cyclic ester include propiolactone, β-methyl-δ-valerolactone, and ε-caprolactone.

Examples of the polycarbonate polyols include reaction products of a polyhydric alcohol and phosgene, and ring-opening polymers of a cyclic carbonate (an alkylene carbonate or the like).

Examples of the polyhydric alcohol include the polyhydric alcohols exemplified in the description of the polyester polyols. Examples of the alkylene carbonate include ethylene carbonate, trimethylene carbonate, tetramethylene carbonate, and hexamethylene carbonate.

The polycarbonate polyols may be compounds with a carbonate bond in the molecule thereof and with a terminal hydroxy group, and may have an ester bond as well as a carbonate bond.

Examples of the monofunctional (meth)acrylate compound with an isocyanate group include 2-isocyanatoethyl methacrylate and 2-isocyanatoethyl acrylate.

Although various compounds can be used as the polyfunctional radically polymerizable compound (A-1) according to the present embodiment, in particular, a urethane (meth)acrylate compound is easy to synthesize, is easily available, and provides a modeling product with high toughness. A polyfunctional radically polymerizable compound with a polyether structure has low viscosity, has good liquid drainage during modeling, and provides a cured product with high accuracy. A polyfunctional radically polymerizable compound with a polyester structure or a polycarbonate structure provides a cured product with high toughness.

The polyfunctional radically polymerizable compound (A-1) may be a single compound thereof or may contain two or more of these compounds. The term “polyfunctional radically polymerizable compound (A-1)” in the present embodiment refers collectively to one or more polyfunctional radically polymerizable compounds contained in a photocurable resin composition.

The amount of the polyfunctional radically polymerizable compound (A-1) in the photocurable resin composition according to the present embodiment is preferably 20 parts by mass or more and 75 parts by mass or less per 100 parts by mass of the polyfunctional radically polymerizable compound (A-1) and a monofunctional radically polymerizable compound (A-2) described later in total. A polyfunctional radically polymerizable compound (A-1) content of 20 parts by mass or more results in a photocurable resin composition with high curability and a cured product with high toughness. A polyfunctional radically polymerizable compound (A-1) content of 75 parts by mass or less results in a photocurable resin composition with moderately low viscosity suitable for three-dimensional modeling. The polyfunctional radically polymerizable compound (A-1) content of the photocurable resin composition is preferably 20 parts by mass or more and 75 parts by mass or less, more preferably 30 parts by mass or more and 75 parts by mass or less, per 100 parts by mass of the polyfunctional radically polymerizable compound (A-1) and the monofunctional radically polymerizable compound (A-2) in total. A polyfunctional radically polymerizable compound (A-1) content in such a range results in a photocurable resin composition with moderate viscosity and high formability and a cured product with good mechanical properties.

### <Component (A-2): Monofunctional Radically Polymerizable Compound>

The monofunctional radically polymerizable compound (A-2) contained in the photocurable resin composition according to the present embodiment is a compound with one radically polymerizable functional group in the molecule thereof. The photocurable resin composition containing the monofunctional radically polymerizable compound (A-2) can have a viscosity suitable for three-dimensional modeling. The mechanical characteristics of a cured product produced by curing the photocurable resin composition can be adjusted in a desired range by adjusting the amount of the monofunctional radically polymerizable compound (A-2) to be added or by appropriately selecting the type of the monofunctional radically polymerizable compound (A-2).

Examples of the monofunctional radically polymerizable compound (A-2) include, but are not limited to, acrylamide compounds, (meth)acrylate compounds, maleimide compounds, styrene compounds, acrylonitrile compounds, vinyl ester compounds, N-vinyl compounds, such as N-vinylpyrrolidone, conjugated diene compounds, vinyl ketone compounds, and vinyl halide/vinylidene halide compounds. In particular, acrylamide compounds, (meth)acrylate compounds, maleimide monomers, and N-vinyl compounds provide a photocurable resin composition with high curability and a cured product with good mechanical characteristics.

Examples of the acrylamide compound include (meth)acrylamide, N-methyl (meth)acrylamide, N-isopropyl (meth)acrylamide, N-tert-butyl (meth)acrylamide, N-phenyl (meth)acrylamide, N-methylol (meth)acrylamide, N,N-diacetone (meth)acrylamide, N,N-dimethyl (meth)acrylamide, N,N-diethyl (meth)acrylamide, N,N-dipropyl (meth)acrylamide, N,N-dibutyl (meth)acrylamide, N-(meth)acryloylmorpholine, N-(meth)acryloyl piperidine, N-[3-(dimethylamino)propyl]acrylamide, and N-tert-octyl (meth)acrylamide.

Examples of the (meth)acrylate compound include methyl (meth)acrylate, ethyl (meth)acrylate, n-butyl (meth)acrylate, isobutyl (meth)acrylate, t-butyl (meth)acrylate, 2-ethylhexyl (meth)acrylate, n-octyl (meth)acrylate, i-octyl (meth)acrylate, lauryl (meth)acrylate, stearyl (meth)acrylate, cyclohexyl (meth)acrylate, isobornyl (meth)acrylate, adamantyl (meth)acrylate, 3-hydroxy-1-adamantyl (meth)acrylate, 3,5-dihydroxy-1-adamantyl (meth)acrylate, 2-methyl-2-adamantyl (meth)acrylate, 2-ethyl-2-adamantyl (meth)acrylate, 2-isopropyl-2-adamantyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, 3-methyl-3-oxetanyl-methyl (meth)acrylate, tetrahydrofurfuryl (meth)acrylate, phenylglycidyl (meth)acrylate, dimethylaminomethyl (meth)acrylate, phenylcellosolve (meth)acrylate, dicyclopentenyl (meth)acrylate, dicyclopentenyloxyethyl (meth)acrylate, biphenyl (meth)acrylate, 2-hydroxyethyl (meth)acryloyl phosphate, phenyl (meth)acrylate, phenoxyethyl (meth)acrylate, phenoxypropyl (meth)acrylate, benzyl (meth)acrylate, butoxytriethylene glycol (meth)acrylate, 2-ethylhexyl poly(ethylene glycol) (meth)acrylate, nonylphenyl poly(propylene glycol) (meth)acrylate, methoxydipropylene glycol (meth)acrylate, glycerol (meth)acrylate, trifluoromethyl (meth)acrylate, trifluoroethyl (meth)acrylate, tetrafluoropropyl (meth)acrylate, octafluoropentyl acrylate, poly(ethylene glycol) (meth)acrylate, poly(propylene glycol) (meth)acrylate, allyl (meth)acrylate, 2,2,2-trifluoroethyl (meth)acrylate, 2,2,3,3-tetrafluoropropyl (meth)acrylate, 1H,1H,5H,octafluoropentyl (meth)acrylate epichlorohydrin-modified butyl (meth)acrylate, epichlorohydrin-modified phenoxy (meth)acrylate, ethylene oxide (EO)-modified phthalic acid (meth)acrylate, EO-modified succinic acid (meth)acrylate, caprolactone-modified 2-hydroxyethyl (meth)acrylate, N,N-dimethylaminoethyl (meth)acrylate, N,N-diethylaminoethyl (meth)acrylate, morpholino (meth)acrylate, EO-modified phosphoric acid (meth)acrylate, α-allyloxymethylacrylic acid methyl (product name: AO-MA, manufactured by Nippon Shokubai Co., Ltd.), (meth)acrylates with an imide group (product name: M-140, manufactured by Toagosei Co., Ltd.), and monofunctional (meth)acrylates with a siloxane structure.

Examples of the maleimide monomers include maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide.

Examples of other monofunctional radically polymerizable compounds include styrene derivatives, such as styrene, vinyltoluene, α-methylstyrene, chlorostyrene, and styrene sulfonic acid and salts thereof, vinyl esters, such as vinyl acetate, vinyl propionate, vinyl pivalate, vinyl benzoate, and vinyl cinnamate, vinyl cyanide compounds, such as (meth)acrylonitrile, and N-vinyl compounds, such as N-vinylpyrrolidone, N-vinylcaprolactam, N-vinylimidazole, N-vinylmorpholine, and N-vinylacetamide.

These monofunctional radically polymerizable compounds may be used alone or in combination.

The amount of the monofunctional radically polymerizable compound (A-2) in the photocurable resin composition according to the present embodiment is preferably 25 parts by mass or more and 80 parts by mass or less per 100 parts by mass of the polyfunctional radically polymerizable compound (A-1) and the monofunctional radically polymerizable compound (A-2) in total. A monofunctional radically polymerizable compound (A-2) content of 25 parts by mass or more results in a photocurable resin composition with moderately low viscosity suitable for three-dimensional modeling. A monofunctional radically polymerizable compound (A-2) content of 80 parts by mass or less results in a photocurable resin composition with high curability and a cured product with high toughness. The amount of the monofunctional radically polymerizable compound (A-2) in the photocurable resin composition according to the present embodiment is more preferably 25 parts by mass or more and 70 parts by mass or less. A monofunctional radically polymerizable compound (A-2) content in such a range results in a photocurable resin composition that has moderate viscosity and high formability and forms a cured product with good mechanical properties.

### <Ethylenically Unsaturated Group Equivalent of Component (A)>

From the perspective of the mechanical properties of a cured product, the radically polymerizable component (A) contained in the photocurable resin composition according to the present embodiment preferably has an ethylenically unsaturated group equivalent of 500 g/eq or more and 2500 g/eq or less, more preferably 500 g/eq or more and 2000 g/eq or less. An ethylenically unsaturated group equivalent of the radically polymerizable component (A) in such a range results in a cured product with a cross-linking density in an appropriate range and a cured product with a good balance between toughness, heat resistance, and elastic modulus, in addition to good sliding characteristics, which are main advantages of the present embodiment.

The term “ethylenically unsaturated group equivalent” in the present embodiment is defined as a value calculated by dividing the weight-average molecular weight of a radically polymerizable compound by the number of ethylenically unsaturated groups per molecule. A higher ethylenically unsaturated group equivalent results in a cured product with a lower cross-linking density after photocuring and a cured product with higher toughness. When a photocurable resin composition contains a plurality of radically polymerizable compounds, a value obtained by weighted averaging the ethylenically unsaturated group equivalent of each of the radically polymerizable compounds by the mass ratio in the photocurable resin composition is defined as the ethylenically unsaturated group equivalent of the radically polymerizable component (A).

The weight-average molecular weight (Mw) of a radically polymerizable compound in the present embodiment is a weight-average molecular weight based on polystyrene standards. The weight-average molecular weight can be measured with a high-performance liquid chromatography (high performance GPC apparatus “HLC-8220 GPC” manufactured by Tosoh Corporation) equipped with two columns Shodex GPCLF-804 (exclusion limit molecular weight: 2×10⁶, separation range: 300 to 2×10⁶) connected in series.

### <Component (B): Metallic Soap>

The metallic soap (B) in the photocurable resin composition according to the present embodiment is formed by binding of a long-chain fatty acid to a metal ion and has both a hydrophobic portion based on the fatty acid moiety and a hydrophilic portion based on the binding site to the metal ion. Examples of the long-chain fatty acid include saturated fatty acids, unsaturated fatty acids, and aliphatic dicarboxylic acids. Among these, saturated fatty acids and unsaturated fatty acids with 12 or more carbon atoms, particularly saturated fatty acids with 12 or more and 30 or less carbon atoms, can impart high lubricity. Examples of the metal ion include zinc, calcium, magnesium, aluminum, barium, lithium, sodium, potassium, and manganese.

Specific examples of the metallic soap include lithium stearate, lithium 12-hydroxystearate, lithium laurate, lithium oleate, lithium 2-ethylhexanoate, lithium behenate, lithium montanate, sodium stearate, sodium 12-hydroxystearate, sodium laurate, sodium oleate, sodium 2-ethylhexanoate, sodium behenate, sodium montanate, potassium stearate, potassium 12-hydroxystearate, potassium laurate, potassium oleate, potassium 2-ethylhexanoate, potassium behenate, potassium montanate, magnesium stearate, magnesium 12-hydroxystearate, magnesium laurate, magnesium oleate, magnesium 2-ethylhexanoate, magnesium behenate, magnesium montanate, calcium stearate, calcium 12-hydroxystearate, calcium laurate, calcium oleate, calcium 2-ethylhexanoate, calcium behenate, calcium montanate, barium stearate, barium 12-hydroxystearate, barium laurate, barium behenate, barium montanate, zinc stearate, zinc 12-hydroxystearate, zinc laurate, zinc oleate, zinc 2-ethylhexanoate, zinc behenate, zinc montanate, lead stearate, lead 12-hydroxystearate, lead behenate, lead montanate, cobalt stearate, aluminum stearate, manganese oleate, barium ricinoleate, aluminum behenate, and aluminum montanate.

Among these specific examples of metallic soaps, the long-chain fatty acid may be selected from the group consisting of lauric acid, myristic acid, pentadecylic acid, palmitic acid, margaric acid, stearic acid, 12-hydroxystearic acid, arachidic acid, behenic acid, lignoceric acid, montanic acid, naphthenic acid, oleic acid, and ricinoleic acid, and the metal ion may be selected from the group consisting of zinc, calcium, magnesium, aluminum, barium, lithium, sodium, and potassium.

Furthermore, from the perspective of availability and high lubricity, the long-chain fatty acid may be selected from the group consisting of lauric acid, stearic acid, 12-hydroxystearic acid, behenic acid, and montanic acid, and the metal ion may be selected from the group consisting of zinc, calcium, magnesium, aluminum, barium, lithium, sodium, and potassium. Zinc stearate may be selected from the perspective of the balance between economic efficiency and lubricity. These may be used alone or in combination.

The upper limit of the average particle size of the metallic soap (B) according to the present embodiment is preferably, but not limited to, 50 μm or less. In an optical modeling method, typically, layers each having a thickness of 200 μm or less, particularly 100 μm or less, are stacked. Thus, an average particle size of 50 μm or less can result in a cured product in which the metallic soap (B) in each layer has high uniformity. More preferably, the metallic soap (B) has an average particle size of 4 μm or less. An average particle size of 4 μm or less can result in a photocurable resin composition with high storage stability due to a sufficiently reduced separation rate of the metallic soap (B) in the photocurable resin composition. The lower limit of the average particle size of the metallic soap (B) is preferably, but not limited to, 0.1 μm or more from the perspective of availability.

The average particle size of the metallic soap (B) according to the present embodiment can be a volume-average particle size by a dynamic light scattering method or a median calculated from a scanning electron microscope (SEM) image, depending on the size. In general, the particle size suitable for the dynamic light scattering method is several micrometers, and the average particle size of particles with a size difficult to measure by the dynamic light scattering method may be calculated from a SEM image. A measuring apparatus using the dynamic light scattering method may be Nanotrac Wave II EX150 manufactured by MicrotracBEL Corp. To calculate the average particle size from a SEM image, the area occupied by a plurality of (100 or more) particles is measured from a SEM image, the equivalent circular diameter of the area is calculated, and the median of the equivalent circular diameter is defined as the average particle size of the particles.

The amount of the metallic soap (B) in the photocurable resin composition according to the present embodiment is preferably, but not limited to, 0.01 parts by mass or more and 15 parts by mass or less, more preferably 0.01 parts by mass or more and 7.5 parts by mass or less, still more preferably 0.05 parts by mass or more and 5.0 parts by mass or less, per 100 parts by mass of the radically polymerizable component (A). An addition amount of the metallic soap (B) in such a range is expected to result in a photocurable resin composition with viscosity applicable to the three-dimensional modeling method and a cured product with good sliding characteristics.

### <Difference in HSP Value Between Radically Polymerizable Component (A) and Metallic Soap (B)>

In the photocurable resin composition according to the present embodiment, the radically polymerizable component (A) and the metallic soap (B) may have high affinity for each other. A high affinity between the radically polymerizable component (A) and the metallic soap (B) can enhance the dispersion stability of the metallic soap (B) in the radically polymerizable component (A) and result in a photocurable resin composition with high storage stability. This also results in a large interaction between the radically polymerizable component (A) and the metallic soap (B) and contributes to enhancing the impact resistance of a cured product.

The HSP value (Hansen solubility parameters) is one of the evaluation methods to quantify the affinity between the radically polymerizable component (A) and the metallic soap (B). The HSP value is a parameter proposed by Charles M. Hansen and is well known as a useful tool for predicting compatibility between compounds. The HSP value is a measure that can be theoretically or experimentally derived, and has three parameters consisting of δD, δP, and δH. The HSP value of a material can be understood as a coordinate in a three-dimensional space (HSP space) with three parameters, such as (δD, δP, δH), as coordinate axes. In the present embodiment, the parameters δD, δP, and δH are expressed in [MPa^{1/2}]. The physical meaning of each parameter is as follows:

δD: energy derived from London dispersion force,
δP: energy derived from dipole interaction, and
δH: energy derived from hydrogen bond strength.

The difference in HSP value between the radically polymerizable component (A) and the metallic soap (B) in the present embodiment is defined as described below. The difference in HSP value Diff(HSP(A), HSP(B)) between the radically polymerizable component (A) and the metallic soap (B) is represented by the following formula, wherein δD(A), δP(A), and δH(A) denote the HSP value of the radically polymerizable component (A), and δD(B), δP(B), and δH(B) denote the HSP value of the metallic soap (B).

$$Diff ( HSP ( A ) , HS P ( B ) ) ≡ \sqrt{\begin{matrix}4 {( δ D ( A ) - δ D ( B ) )}^{2} + \\ \begin{matrix}{( δ P ( A ) - δ P ( B ) )}^{2} + \\ {( δ H ( A ) - δ H ( B ) )}^{2}\end{matrix}\end{matrix}} \qquad [ Math . 1 ]$$

When the radically polymerizable component (A) and/or the metallic soap (B) is a mixture containing two or more materials, the HSP value is calculated by multiplying the HSP value of each material by the volume ratio of each material to the whole mixture and by summing up the results. For example, consider a mixture of Component 1 and Component 2. The HSP value of the mixture (δD(m), δP(m), δH(m)) is represented by the following formulae, wherein (δD(1), δP(1), δH(1)), d₁ (g/mL), and w₁ (% by weight) denote the HSP value, density, and mass ratio of Component 1, respectively, and (δD(2), δP(2), δH(2)), d₂ (g/mL), and w₂ (% by weight) denote the HSP value, density, and mass ratio of Component 2, respectively.

$$δ D ( m ) = \frac{{d}_{2} {w}_{1}}{{d}_{2} {w}_{1} + {d}_{1} {w}_{2}} δ d ( 1 ) + \frac{{d}_{1} {w}_{2}}{{d}_{2} {w}_{1} + {d}_{1} {w}_{2}} δ D ( 2 ) \qquad [ Math . 2 ]$$

$$δ P ( m ) = \frac{{d}_{2} {w}_{1}}{{d}_{2} {w}_{1} + {d}_{1} {w}_{2}} δ P ( 1 ) + \frac{{d}_{1} {w}_{2}}{{d}_{2} {w}_{1} + {d}_{1} {w}_{2}} δ P ( 2 )$$

$$δ H ( m ) = \frac{{d}_{2} {w}_{1}}{{d}_{2} {w}_{1} + {d}_{1} {w}_{2}} δ H ( 1 ) + \frac{{d}_{1} {w}_{2}}{{d}_{2} {w}_{1} + {d}_{1} {w}_{2}} δ H ( 2 )$$

Although the Hansen solubility parameters can be obtained by various methods, first of all, the Hansen solubility parameters can be obtained from known information, such as a database or literature. For a material without known information, there may be two methods: a computational method and an experimental method. A computational method has a plurality of known protocols for estimating the HSP value using the chemical structure of a molecule as an input, and specific examples thereof include a method using commercially available software, such as Hansen Solubility Parameters in Practice (HSPiP), the Krevelen-Hoftyzer method, the Hoy method, the Stefanis & Panayiotou method, and an estimation method using a method described in ACS Omega. 2018 Dec. 31; 3(12): 17049-17056. In the present embodiment, unless otherwise specified, the method described in ACS Omega. 2018 Dec. 31; 3(12): 17049-17056 is employed as a method for estimating the HSP value. The experimental method may be the Hansen solubility sphere method. The Hansen solubility sphere method is described in detail below.

Consider determining the HSP value of a target material. The solubility of the target material is tested using various solvents with known HSP values. When the HSP value of each solvent is plotted in the HSP space, a sphere is defined in the HSP space such that the HSP value of a good solvent for the target material is located inside and the HSP value of a poor solvent for the target material is located outside, and the center of the sphere is used as the HSP value of the target material. The sphere thus defined is often referred to as a solubility sphere. Some materials have two or more solubility spheres as a result of experiments. This is often seen when the material has both a hydrophobic moiety and a hydrophilic moiety and is seen, for example, in an ionic liquid, a metallic soap, or the like. To determine the HSP value of the metallic soap (B) according to the present embodiment by the Hansen solubility sphere method, in the presence of a plurality of solubility spheres as described above, the HSP value of the metallic soap (B) is defined by the center of the solubility sphere present in the most hydrophobic region in the HSP space. The phrase “present in a more hydrophobic region”, as used herein, refers to present in a region with smaller δP or δH.

In the photocurable resin composition according to the present embodiment, the difference in HSP value between the radically polymerizable component (A) and the metallic soap (B) determined by the method described above is 0 MPa^{1/2} or more and 8.0 MPa^{1/2} or less. When the difference in HSP value between the radically polymerizable component (A) and the metallic soap (B) is 8.0 MPa^{1/2} or less, this results in good compatibility between the radically polymerizable component (A) and the metallic soap (B). This reduces the sedimentation or flotation of the metallic soap (B) due to the density difference between the radically polymerizable component (A) and the metallic soap (B), suppresses separation of the metallic soap (B) from the radically polymerizable component (A), and results in a photocurable resin composition with high storage stability.

One reason why a photocurable resin composition with a HSP difference satisfying the above condition has unexpectedly high dispersion stability is considered as described below. The metallic soap is formed as an aggregate of surfactant molecules, and the molecules are not substantially linked to each other by a covalent bond. Thus, the metallic soap with high dispersibility in the photocurable resin composition may become smaller than the particle size at the time of charging and may be stabilized in the system. In this respect, the metallic soap is greatly different from cross-linked particles, such as silica particles, which have a bond network inside the particles and are substantially difficult to make smaller than the particle size at the time of charging. Thus, in addition to the contribution to the dispersion stability, the influence of scattering on the modeling accuracy can be reduced to a low level, thereby further enhancing the applicability of the photocurable resin composition according to the present embodiment to an optical modeling method.

### <Curing Agent (C)>

In the present embodiment, the curing agent (C) may be a radical photopolymerization initiator. The photocurable resin composition may contain a thermal radical polymerization initiator in addition to a radical photopolymerization initiator. When the photocurable resin composition contains a thermal radical polymerization initiator, heat treatment after modeling by light irradiation can further improve the mechanical characteristics of a modeling product.

### [Radical Photopolymerization Initiator]

Radical photopolymerization initiators are broadly classified into an intramolecular cleavage type and a hydrogen abstraction type. In the intramolecular cleavage type, a bond of a specific site is broken by absorbing light of a specific wavelength, and a radical is generated at the broken site. The radical acts as a polymerization initiator and initiates a polymerization of the polyfunctional radically polymerizable compound (A-1) and the monofunctional radically polymerizable compound (A-2). The hydrogen abstraction type absorbs light of a specific wavelength and has an excited state. The excited species causes a hydrogen abstraction reaction from a neighboring hydrogen donor and generates a radical. The radical acts as a polymerization initiator and initiates a polymerization of the polyfunctional radically polymerizable compound (A-1) and the monofunctional radically polymerizable compound (A-2).

Known intramolecular cleavage type radical photopolymerization initiators include alkylphenone radical photopolymerization initiators, acylphosphine oxide radical photopolymerization initiators, and oxime ester radical photopolymerization initiators. These types undergo α-cleavage of a bond adjacent to a carbonyl group and generate a radical species. Examples of the alkylphenone radical photopolymerization initiators include benzyl methyl ketal radical photopolymerization initiators, α-hydroxyalkylphenone radical photopolymerization initiators, and aminoalkylphenone radical photopolymerization initiators. Examples of specific compounds include, but are not limited to, benzyl methyl ketal radical photopolymerization initiators, such as 2,2′-dimethoxy-1,2-diphenylethan-1-one (OMNIRAD (registered trademark) 651, manufactured by IGM RESINS B.V.), α-hydroxyalkylphenone radical photopolymerization initiators, such as 2-hydroxy-2-methyl-1-phenylpropan-1-one (OMNIRAD (registered trademark) 1173, manufactured by IGM RESINS B.V.), 1-hydroxycyclohexyl phenyl ketone (OMNIRAD (registered trademark) 184, manufactured by IGM RESINS B.V.), 1-[4-(2-hydroxyethoxy)phenyl]-2-hydroxy-2-methyl-1-propan-1-one (OMNIRAD (registered trademark) 2959, manufactured by IGM RESINS B.V.), 2-hydroxy-1-{4-[4-(2-hydroxy-2-methylpropionyl)benzyl]phenyl}-2-methylpropan-1-one (OMNIRAD (registered trademark) 127, manufactured by IGM RESINS B.V.), and aminoalkylphenone radical photopolymerization initiators, such as 2-methyl-1-(4-methylthiophenyl)-2-morpholinopropan-1-one (OMNIRAD (registered trademark) 907, manufactured by IGM RESINS B.V.) and 2-benzylmethyl-2-dimethylamino-1-(4-morpholinophenyl)-1-butanone (OMNIRAD (registered trademark) 369, manufactured by IGM RESINS B.V.). Examples of the acylphosphine oxide radical photopolymerization initiators include, but are not limited to, 2,4,6-trimethylbenzoyldiphenylphosphine oxide (Lucirin TPO, manufactured by BASF) and bis(2,4,6-trimethylbenzoyl)-phenylphosphine oxide (OMNIRAD (registered trademark) TPO H, manufactured by IGM RESINS B.V.). Examples of the oxime ester radical photopolymerization initiators include, but are not limited to, (2E)-2-(benzoyloxyimino)-1-[4-(phenylthio)phenyl]octan-1-one (Irgacure OXE-01, manufactured by BASF). The trade names in parentheses are examples.

Examples of the hydrogen abstraction type radical photopolymerization initiators include, but are not limited to, anthraquinone derivatives, such as 2-ethyl-9,10-anthraquinone and 2-t-butyl-9,10-anthraquinone, and thioxanthone derivatives, such as isopropylthioxanthone and 2,4-diethylthioxanthone.

In the present embodiment, radical photopolymerization initiators may be used alone or in combination. Furthermore, a thermal radical polymerization initiator may be contained to promote a polymerization reaction in heat treatment after modeling.

The amount of the radical photopolymerization initiator to be added to the photocurable resin composition according to the present embodiment is preferably 0.1 parts by mass or more and 15 parts by mass or less, more preferably 0.1 parts by mass or more and 10 parts by mass or less, per 100 parts by mass of the radically polymerizable component (A). In such a range, the photocurable resin composition can have high optical transparency and can be sufficiently and uniformly polymerized.

### [Thermal Radical Polymerization Initiator]

The thermal radical polymerization initiator may be any known compound that can generate a radical upon heating, and may be an azo compound, a peroxide, or a persulfate. Examples of the azo compound include 2,2′-azobisisobutyronitrile, 2,2′-azobis(methyl isobutyrate), 2,2′-azobis-2,4-dimethylvaleronitrile, and 1,1′-azobis(1-acetoxy-1-phenylethane). Examples of the peroxide include benzoyl peroxide, di-tert-butyl benzoyl peroxide, tert-butyl peroxypivalate, and di(4-tert-butylcyclohexyl) peroxydicarbonate. Examples of the persulfate include ammonium persulfate, sodium persulfate, and potassium persulfate.

The amount of the thermal radical polymerization initiator to be added is preferably 0.1 parts by mass or more and 15 parts by mass or less, more preferably 0.1 parts by mass or more and 10 parts by mass or less, per 100 parts by mass of the radically polymerizable component (A). In such a range, a cured product has a high molecular weight and good physical properties.

### <Other Components>

The photocurable resin composition according to the present embodiment may contain various additive agents as other optional components within the scope of not impairing the objects and advantages of the present embodiment. Examples of the additive agents include resins, such as epoxy resin, polyurethane, polybutadiene, polychloroprene, polyester, styrene-butadiene block copolymer, polysiloxane, petroleum resin, xylene resin, ketone resin, and cellulose resin; engineering plastics, such as polycarbonate, modified poly(phenylene ether), polyamide, polyacetal, poly(ethylene terephthalate), poly(butylene terephthalate), polyphenylsulfone, polysulfone, polyarylate, poly(ether imide), poly(ether ether ketone), poly(phenylene sulfide), poly(ether sulfone), polyamideimide, liquid crystal polymers, polytetrafluoroethylene, polychlorotrifluoroethylene, and poly(vinylidene difluoride); reactive monomers, such as fluorinated oligomers, silicone oligomers, polysulfide oligomers, fluorine-containing monomers, and monomers with a siloxane structure; soft metals, such as gold, silver, and lead; materials with a layered crystal structure, such as graphite, molybdenum disulfide, tungsten disulfide, boron nitride, melanin cyanurate, graphite fluoride, calcium fluoride, barium fluoride, lithium fluoride, silicon nitride, and molybdenum selenide; solid particles, such as silica particles, PTFE particles, elastomer particles, polysilsesquioxane particles, silicone rubber particles, acrylic particles, nylon particles, and core-shell elastomer particles with a surface covered with a different polymer (for example, silicone composite particles in which silicone rubber particles are covered with silicone resin); polymerization inhibitors, such as phenothiazine and 2,6-di-t-butyl-4-methylphenol; photosensitizers, such as benzoin compounds, acetophenone compounds, anthraquinone compounds, thioxanthone compounds, ketal compounds, benzophenone compounds, tertiary amine compounds, and xanthone compounds; and polymerization initiation aids, leveling agents, wettability improving agents, surfactants, plasticizers, ultraviolet absorbers, silane coupling agents, inorganic fillers, pigments, dyes, antioxidants, flame retardants, thickeners, antifoaming agents, and lubricants.

Among these, in particular, silicone oil composed mainly of a polysiloxane backbone is suitable for combination with the metallic soap (B). The addition of silicone oil can be expected to reduce foaming at the time of modeling and make the whole system hydrophobic, thereby increasing the affinity for the metallic soap (B) and providing a high degree of dispersion stability. Furthermore, silicone oil itself also functions as a lubricating component and is useful for enhancing the sliding characteristics of a cured product.

The silicone oil is, for example, one or two or more of straight silicone oils, such as a linear dimethyl silicone oil, a cyclic dimethyl silicone oil, a methylphenyl silicone oil, and a methyl hydrogen silicone oil, and nonreactive modified silicone oils, and may particularly be a linear dimethyl silicone oil.

The silicone oil content of the photocurable resin composition according to the present embodiment is preferably 0 parts by mass or more and 5 parts by mass or less per 100 parts by mass of the radically polymerizable component (A) and the metallic soap (B) in total. A silicone oil content in the above range results in a photocurable resin composition with high storage stability and a cured product with both good mechanical properties and good sliding characteristics.

### <Method for Producing Photocurable Resin Composition>

The photocurable resin composition according to the present embodiment is produced by adding an appropriate amount of another optional component to the essential components, that is, the radically polymerizable component (A), the metallic soap (B), and the curing agent (C). More specifically, the photocurable resin composition according to the present embodiment can be produced by stirring these components in a stirring vessel typically at 30° C. or more and 120° C. or less, preferably 50° C. or more and 100° C. or less. The stirring time is typically 1 minute or more and 6 hours or less, preferably 10 minutes or more and 2 hours or less. The total of the radically polymerizable component (A) content and the metallic soap (B) content is preferably 25 parts by mass or more and 100 parts by mass or less, more preferably 75 parts by mass or more and 100 parts by mass or less, per 100 parts by mass of the photocurable resin composition excluding the curing agent (C). The curing agent (C) and other components constitute the remainder of 100 parts by mass of the photocurable resin composition excluding the radically polymerizable component (A) and the metallic soap (B).

The photocurable resin composition according to the present embodiment preferably has a viscosity of 50 mPa·s or more and 30,000 mPa·s or less, more preferably 50 mPa·s or more and 10,000 mPa·s or less, at 25° C.

The photocurable resin composition according to the present embodiment is suitably used as a material for modeling by an optical modeling method. Thus, an article (three-dimensional object) with a desired shape can be produced by irradiating the photocurable resin composition according to the present embodiment with a light energy beam in accordance with slice data generated from three-dimensional shape data of a modeling article (modeling model) and supplying energy necessary for curing.

### <Cured Product>

A cured product according to the present embodiment can be produced by curing the photocurable resin composition by light energy irradiation. The light energy beam may be ultraviolet radiation or infrared radiation. In particular, a light beam with a wavelength of 300 nm or more and 450 nm or less may be used because it is easily available due to its versatility and because the energy is easily absorbed by a radical photopolymerization initiator. A light source of the light energy beam can be an ultraviolet or infrared laser (for example, Ar laser, He—Cd laser, or the like), a mercury lamp, a xenon lamp, a halogen lamp, or a fluorescent lamp. In particular, the laser source may be employed because it can increase the energy level to shorten the modeling time and, due to its good light-harvesting properties, it can reduce the irradiation diameter to achieve high modeling accuracy. The light energy beam can be appropriately selected according to the type of radical polymerization initiator contained in a photocurable resin composition, and a plurality of light energy beams can be used in combination.

### <Method for Producing Three-Dimensional Object>

The photocurable resin composition according to the present embodiment contains a photopolymerization initiator, such as a radical photopolymerization initiator, as the curing agent (C), and is therefore suitable as a modeling material used for an optical modeling method. In other words, a three-dimensional object of the photocurable resin composition according to the present embodiment can be produced by a known optical modeling method. A method for producing a three-dimensional object by an optical modeling method includes the step of providing a photocurable resin composition in a predetermined thickness and the step of curing the photocurable resin composition by applying light energy to the photocurable resin composition on the basis of slice data of a modeling model. The method for producing a three-dimensional object by an optical modeling method may further include the step of heat-treating a three-dimensional object produced by light energy irradiation. The light energy used for the irradiation may be laser light or light from a projector. Typical examples of the optical modeling method may be roughly divided into two types: a free liquid surface method and a regulated liquid surface method.

FIGURE illustrates an example of an optical modeling apparatus 100 using the free liquid surface method. The optical modeling apparatus 100 includes a vessel 11 filled with a liquid photocurable resin composition 10. A modeling stage 12 is provided inside the vessel 11 so as to be driven in the vertical direction by a drive shaft 13. A light energy beam 15 emitted from a light source 14 can be changed in irradiation position by a galvanometer mirror 16 controlled by a control unit 18 in accordance with slice data and scan the surface of the vessel 11. In FIGURE, the scan range of the light energy beam 15 is indicated by a thick broken line.

The thickness d of the photocurable resin composition 10 to be cured by the light energy beam 15 depends on the setting at the time of generation of the slice data and affects the accuracy of a three-dimensional object 17 (reproducibility of three-dimensional shape data of a modeling article). The thickness d is achieved by controlling the driving amount of the drive shaft 13 with the control unit 18.

First, the control unit 18 controls the drive shaft 13 on the basis of the setting to supply the photocurable resin composition with the thickness d on the modeling stage 12. The liquid photocurable resin composition on the modeling stage 12 is selectively irradiated with a light energy beam on the basis of the slice data to form a cured layer with a desired pattern. The modeling stage 12 is then moved in the direction of the white arrow to supply an uncured photocurable resin composition with the thickness d to the surface of the cured layer. The light energy beam 15 is then emitted on the basis of the slice data to form a cured product integrated with the previously formed cured layer. The step of stacking such cured layers each having a predetermined thickness d is performed multiple times to produce the three-dimensional object 17.

The three-dimensional object 17 thus produced is taken out from the vessel 11. After an unreacted photocurable resin composition remaining on the surface of the three-dimensional object 17 is removed, the three-dimensional object 17 is subjected to cleaning or post-processing, if necessary. A cleaning agent used for the cleaning can be an alcohol organic solvent exemplified by an alcohol, such as isopropyl alcohol or ethyl alcohol. A ketone organic solvent exemplified by acetone, ethyl acetate, or methyl ethyl ketone, or an aliphatic organic solvent exemplified by a terpene may also be used. Cleaning with the cleaning agent is followed by post-processing as required. For example, post-curing by light irradiation and/or heat irradiation may be performed. The post-curing can cure the unreacted photocurable resin composition remaining on the surface and inside of the three-dimensional object, reduce stickiness of the surface of the three-dimensional object, and improve the initial strength of the three-dimensional object. The post-processing may be the removal of a support body, polishing of the surface, or shape processing, such as forming a threaded hole.

The light energy beam used for the production may be ultraviolet radiation, an electron beam, X-rays, or radiation. Among these, ultraviolet radiation with a wavelength of 300 nm or more and 450 nm or less may be used due to its versatility and availability at relatively low cost. A light source of ultraviolet radiation can be an ultraviolet laser (for example, Ar laser, He—Cd laser, or the like), UV-LED, a mercury lamp, a xenon lamp, a halogen lamp, or a fluorescent lamp.

When a photocurable resin composition provided to have a predetermined thickness is irradiated with a light energy beam, as described above, the resin can be cured by a stippling method or a line drawing method using a light energy beam narrowed in a dot shape or a line shape. Alternatively, the photocurable resin composition may be cured by planar irradiation with a light energy beam through a planar drawing mask formed by arranging a plurality of minute optical shutters, such as liquid crystal shutters or digital micromirror shutters.

As in the free liquid surface method, modeling by the regulated liquid surface method may also be performed. An optical modeling apparatus using the regulated liquid surface method includes a support stage corresponding to the modeling stage 12 of the optical modeling apparatus 100 of FIGURE provided to raise a three-dimensional object above the liquid surface, and a light irradiation means below the vessel 11. A typical modeling example of the regulated liquid surface method is described below. First, a support surface of a support stage provided to be able to move up and down and a bottom face of a vessel containing a photocurable resin composition are placed at a predetermined distance from each other, and the photocurable resin composition is supplied at a predetermined thickness d between the support surface of the support stage and the bottom face of the vessel. A region according to the slice data of the photocurable resin composition between the stage support surface and the bottom face of the vessel containing the photocurable resin composition is then selectively irradiated with light from a laser source or a projector on the bottom face side of the vessel. Light irradiation cures the photocurable resin composition between the stage support surface and the bottom face of the vessel and forms a cured layer of the photocurable resin composition. The support stage is then raised to separate the cured layer from the bottom face of the vessel.

The height of the support stage is then adjusted so that the cured layer formed on the support stage and the bottom face of the vessel have a predetermined distance d therebetween, and the photocurable resin composition is supplied at a predetermined thickness d between the support surface of the support stage and the bottom face of the vessel. A cured layer bonded to the previously formed cured layer is newly formed between the cured layer and the bottom face of the vessel by selective light irradiation in the same manner as described above. While the light irradiation pattern is changed or not changed according to the slice data, this step is performed a predetermined number of times to form a three-dimensional object composed of a plurality of cured layers integrally stacked.

### <Use>

The photocurable resin composition according to the present embodiment can be suitably used for three-dimensional modeling, and a cured product thereof can be used in a wide range of fields regardless of the application. For example, the photocurable resin composition can be used as a modeling material for a 3D printer in an optical modeling method, and the cured product can be used for various products, such as sports goods, medical and nursing care items, customized products, such as artificial limbs, dentures, and artificial bones, industrial machinery and equipment, precision apparatuses, electrical and electronic devices, electrical and electronic components, and construction materials.

### <Constitutions Included>

The disclosure of the present embodiment includes the following constitutions.

### (Constitution 1)

A photocurable resin composition for three-dimensional modeling, containing a radically polymerizable component (A) and a curing agent (C), wherein the component (A) contains a polyfunctional radically polymerizable compound (A-1) and a monofunctional radically polymerizable compound (A-2),

wherein the photocurable resin composition further contains a metallic soap (B), and

a difference in HSP value between the component (A) and the component (B) is 0 MPa^{1/2} or more and 8.0 MPa^{1/2} or less.

### (Constitution 2)

The photocurable resin composition according to Constitution 1, wherein the radically polymerizable component (A) has an ethylenically unsaturated group equivalent of 500 g/eq or more and 2,500 g/eq or less.

### (Constitution 3)

The photocurable resin composition according to Constitution 1 or 2, wherein a metallic soap (B) content is 0.01 parts by mass or more and 15 parts by mass or less per 100 parts by mass of the radically polymerizable component (A).

### (Constitution 4)

The photocurable resin composition according to any one of Constitutions 1 to 3, wherein the metallic soap (B) has an average particle size of 50 μm or less.

### (Constitution 5)

The photocurable resin composition according to Constitution 4, wherein the metallic soap (B) has an average particle size of 4 μm or less.

### (Constitution 6)

The photocurable resin composition according to any one of Constitutions 1 to 5, wherein the metallic soap (B) is a compound composed of a saturated or unsaturated fatty acid with 12 or more carbon atoms and a metal ion.

### (Constitution 7)

The photocurable resin composition according to Constitution 6, wherein the saturated fatty acid is selected from the group consisting of lauric acid, myristic acid, pentadecylic acid, palmitic acid, margaric acid, stearic acid, 12-hydroxystearic acid, arachidic acid, behenic acid, lignoceric acid, montanic acid, and naphthenic acid, the unsaturated fatty acid is selected from the group consisting of oleic acid and ricinoleic acid; and the metal ion is selected from the group consisting of zinc, calcium, magnesium, aluminum, barium, lithium, sodium, and potassium.

### (Constitution 8)

The photocurable resin composition according to Constitution 6, wherein the saturated fatty acid is selected from the group consisting of lauric acid, stearic acid, 12-hydroxystearic acid, behenic acid, and montanic acid, and the metal ion is selected from the group consisting of zinc, calcium, magnesium, aluminum, barium, lithium, sodium, and potassium.

### (Constitution 9)

The photocurable resin composition according to Constitution 6, wherein the metallic soap (B) is zinc stearate.

### (Constitution 10)

The photocurable resin composition according to any one of Constitutions 1 to 9, wherein the monofunctional radically polymerizable compound (A-2) is selected from acrylamide compounds, (meth)acrylate compounds, maleimide compounds, and N-vinyl compounds.

### (Constitution 11)

The photocurable resin composition according to any one of Constitutions 1 to 10, wherein the polyfunctional radically polymerizable compound (A-1) is a (meth)acrylate compound or a urethane (meth)acrylate compound each having a polyether structure, a polyester structure, or a polycarbonate structure.

### (Constitution 12)

The photocurable resin composition according to any one of Constitutions 1 to 11, wherein a polyfunctional radically polymerizable compound (A-1) content is 20 parts by mass or more and 75 parts by mass or less per 100 parts by mass of the polyfunctional radically polymerizable compound (A-1) and the monofunctional radically polymerizable compound (A-2) in total.

### (Constitution 13)

The photocurable resin composition according to any one of Constitutions 1 to 12, further containing a silicone oil.

### (Constitution 14)

A cured product produced by curing the photocurable resin composition according to any one of Constitutions 1 to 13.

### (Constitution 15)

A method for producing a three-dimensional object by an optical modeling method, including the steps of:

providing a photocurable resin composition in a layer form; and

applying light energy to the photocurable resin composition in the layer form based on slice data of a modeling model to cure the photocurable resin composition and form a modeling product,

wherein the photocurable resin composition is the photocurable resin composition according to any one of Constitutions 1 to 13.

### (Constitution 16)

The method for producing a three-dimensional object according to Constitution 15, wherein the light energy is light emitted from a laser source or a projector.

### Examples

The present embodiment will be further described in the following exemplary embodiments, but the present embodiment is not limited to these exemplary embodiments.

### [Polyfunctional Radically Polymerizable Compound (A-1)]

Table 1 shows the polyfunctional radically polymerizable compounds (A-1) used in the exemplary embodiments and comparative examples.

TABLE 1

| | | | Number of | Weight- | Ethylenically | | | | | |
|---|---|---|---|---|---|---|---|---|---|---|
| | | | functional | average | unsaturated | | | | | |
| | | Functional | groups per | molecular | group | δD | δP | δH | | Trade |
| | Comspound | group | molecule | weight | equivalent [g/eq] | [MPa^{1/2}] | [MPa^{1/2}] | [MPa^{1/2}] | Manufacturer | name |
| A-1-1 | Urethane acrylate | Acryloyl | 2 | 3,000 | 1,500 | 16.4 | 9.2 | 6.9 | Mitsubishi | Shikoh |
| | | group | | | | | | | Chemical | UV-6630B |
| | | | | | | | | | Corporation | |
| A-1-2 | Urethane acrylate | Acryloyl | 2 | 10,000 | 5,000 | 17.0 | 7.6 | 6.2 | KSM Co., Ltd. | KUA- |
| | | group | | | | | | | | PC2T |
| A-1-3 | Diacrylate with | Acryloyl | 2 | 304 | 152 | 17.1 | 7.0 | 5.5 | Shin- | NK ester |
| | alicyclic structure | group | | | | | | | Nakamura | A-DCP |
| | | | | | | | | | Chemical Co., | |
| | | | | | | | | | Ltd. | |
| A-1-4 | Epoxidized | Acryloyl | 2 | 466 | 233 | 17.5 | 6.7 | 5.9 | Shin- | NK ester |
| | bisphenol | group | | | | | | | Nakamura | ABE-300 |
| | diacrylate | | | | | | | | Chemical Co., | |
| | | | | | | | | | Ltd. | |
| A-1-5 | Trimethylolpropane | Acryloyl | 3 | 296 | 99 | 16.6 | 8.7 | 6.7 | Osaka | Viscoat |
| | triacrylate | group | | | | | | | Organic | #295 |
| | | | | | | | | | Chemical | |
| | | | | | | | | | Industry Ltd. | |

### [Monofunctional Radically Polymerizable Compound (A-2)]

Table 2 shows the monofunctional radically polymerizable compounds (A-2) used in the exemplary embodiments and comparative examples.

TABLE 2

| | | δD | δP | δH | | |
|---|---|---|---|---|---|---|
| | Compound | [MPa^{1/2}] | [MPa^{1/2}] | [MPa^{1/2}] | Manufacturer | Trade name |
| A-2-1 | 4-acryloylmorpholine | 17.5 | 12.1 | 7.5 | KJ Chemicals | ACMO |
| | | | | | Corporation | |
| A-2-2 | 4-t-butylcyclohexyl | 16.5 | 5.5 | 4.5 | KJ Chemicals | TBCHA |
| | acrylate | | | | Corporation | |
| A-2-3 | Isobornyl methacrylate | 16.7 | 5.5 | 4.5 | Showa Denko | Isobornyl |
| | | | | | Materials Co., Ltd. | methacrylate |
| A-2-4 | Dicyclopentanyl acrylate | 17.3 | 5.9 | 4.8 | Tokyo Chemical | FA-513AS |
| | | | | | Industry Co., Ltd. | |

### [Metallic Soap (B)]

Table 3 shows the metallic soaps (B) used in the exemplary embodiments.

The HSP values in Table 3 were determined as follows:
B-1: quoted from DNT technical report on coatings No. 20 Report-1 “Study on Improvement Coating Quality of Hot-dip Galvanized High Strength Bolt”,
B-2: calculated using a method described in ACS Omega. 2018 Dec. 31; 3(12): 17049-17056, and
B-3: calculated in the same manner as in B-2.

TABLE 3

| | | | | | Average | | |
|---|---|---|---|---|---|---|---|
| | | δD | δP | δH | particle | | Trade |
| | Compound | [MPa^{1/2}] | [MPa^{1/2}] | [MPa^{1/2}] | Size [μm] | Manufacturer | name |
| B-1 | Zinc stearate | 15.6 | 9.6 | 12.1 | 0.5 | Sakai Chemical | SPZ- |
| | | | | | | Industry Co., Ltd. | 100F |
| B-2 | Calcium stearate | 16.5 | 8.7 | 13.2 | 3.6 | Nitto Kasei Co., Ltd. | Ca-St |
| B-3 | Calcium behenate | 17.1 | 9.1 | 10.8 | 2.2 | Nitto Kasei Co., Ltd. | CS-7 |

### [Curing Agent (C)]

C-1: Omnirad 819 (manufactured by IGM Resins, radical photopolymerization initiator, bis(2,4,6-trimethylbenzoyl)phenylphosphine oxide)

### [Other Components]

Table 4 shows components other than the radically polymerizable component (A), the metallic soap (B), and the curing agent (C) used in the exemplary embodiments and comparative examples.

TABLE 4

| | | Average | | |
|---|---|---|---|---|
| | | particle | | |
| | Compound | size | Manufacturer | Trade name |
| EX-1 | Dimethyl | — | Shin-Etsu Chemical Co., Ltd. | KF-96-1, 000cs |
| | silicone oil | | | |
| EX-2 | Silica particles | 6.5 μm | Sekisui Chemical Co., Ltd. | Micropearl SP-2065 |
| EX-3 | Silica particles | 0.5 μm | Admatechs Co., Ltd. | SC2500-SMJ |

### [Preparation of Photocurable Resin Composition]

The components were blended in accordance with the formulae shown in Tables 5 and 6, were heated to 70° C., and were stirred with a stirrer for one hour to prepare a photocurable resin composition.

### [Preparation of Test Specimen]

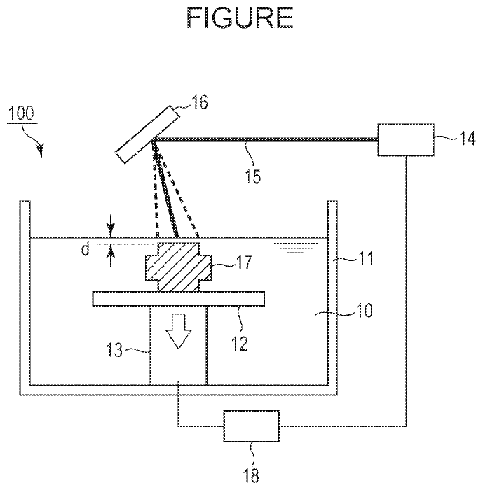

Two rectangular parallelepipeds of 30 mm×30 mm×4 mm and 80 mm×10 mm×4 mm were formed from the photocurable resin composition thus prepared using a 3D printer (FIG. 4 Modular manufactured by 3D Systems, an optical modeling apparatus based on a regulated liquid surface method) in accordance with slice data based on the three-dimensional shape. The rectangular parallelepiped of 30 mm×30 mm×4 mm was formed by stacking a cured layer of 30 mm×4 mm×50 μm in thickness to a height of 30 mm. The rectangular parallelepiped of 80 mm×10 mm×4 mm was formed by stacking a cured layer of 10 mm×4 mm×50 μm in thickness to a height of 80 mm. The modeling products thus formed were irradiated with ultraviolet light for 90 minutes using an LC-3D Print Box UV post-cure unit manufactured by 3D Systems, thereby preparing test specimens. The test specimens thus prepared were used for the evaluation of formability, friction coefficients, specific wear rates, and a Charpy impact test described later.

### [Evaluation]

### (Formability)

The dimensional error of the test specimens with respect to a shape of 30 mm×30 mm×4 mm was evaluated as the success or failure of modeling. The evaluation criteria were described below. Satisfying the evaluation criterion B is judged to be good formability, and satisfying the evaluation criterion A is judged to be excellent formability. The size of each side was measured after modeling with the 3D printer and before post-curing with ultraviolet radiation. Table 5 shows the results.
A: The dimensional error was within ±3%.
B: The dimensional error was more than ±3% and within ±20%.
C: The modeling was impossible.

The phrase “The modeling was impossible”, as used herein, refers to a remarkable failure, such as falling of a three-dimensional object from the modeling stage during the modeling of a test specimen.

### (Friction Coefficient and Specific Wear Rate)

A dynamic friction coefficient was used as a measure of the friction coefficient. The dynamic friction coefficient was measured under the following conditions.

Measuring apparatus: HEIDON Type 20 manufactured by Shinto Scientific Co., Ltd.
Test specimen: 30 mm×30 mm×4 mm
Mating material: SUS 304, a ball 10 mm in diameter

### Load: 100 g

Sliding speed: 53.9 mm/s
Test time: 20 minutes

A test specimen of 30 mm×30 mm×4 mm was fixed to a rotation stage such that the 30 mm×30 mm surface could serve as a sliding surface, and was brought into contact with the stainless steel ball of the mating material at a sliding radius of 5 mm. While a predetermined vertical load was applied to the ball, the stage was rotated at a predetermined speed to measure the force between the sliding surface and the ball made of SUS 304. The measured force was divided by the load to calculate the dynamic friction coefficient. The measurement was performed four times with different samples. The value after 15 minutes from the start of the measurement was adopted in each measurement. The four values thus measured were averaged as the final dynamic friction coefficient. The criteria for sliding characteristics based on the dynamic friction coefficient are described below. Satisfying the evaluation criterion A was judged to be excellent sliding characteristics, satisfying the evaluation criterion B was judged to be good sliding characteristics, and satisfying the evaluation criterion C was judged to be poor sliding characteristics.
A: less than 0.5
B: 0.5 or more and less than 1.0
C: 1.0 or more

The specific wear rate was calculated by the following method from a sliding mark formed on the sliding surface after the measurement of the dynamic friction coefficient. First, the surface profile of the sliding mark was determined with a confocal microscope (OPTELICS C130 manufactured by Lasertec Corporation) to measure the wear volume. Next, the wear volume was divided by the load and the sliding distance to obtain the specific wear rate. The criteria for wear resistance based on the specific wear rate are described below. Satisfying the evaluation criterion A was judged to be very high wear resistance, satisfying the evaluation criterion B was judged to be high wear resistance, and satisfying the evaluation criterion C was judged to be low wear resistance.
A: less than 0.5 mm³·N⁻¹·km⁻¹
B: 0.5 mm³·N⁻¹·km⁻¹ or more and less than 1.0 mm³·N⁻¹·km⁻¹
C: 1.0 mm³·N⁻¹·km⁻¹ or more

### (Charpy Impact Test)

In accordance with JIS K 7111, a 45-degree notch with a depth of 2 mm was formed in the central portion of a 80 mm×10 mm×4 mm test specimen using a notching machine (trade name “Notching Tool A-4” manufactured by Toyo Seiki Seisaku-Sho, Ltd.). The test specimen was broken with an impact tester (trade name “IMPACT TESTER IT”, manufactured by Toyo Seiki Seisaku-Sho, Ltd.) from the back side of the notch at an energy of 0.5 J. The energy required for fracture was calculated from the angle to which a hammer swung up to 150 degrees in advance swung up after the fracture of the test specimen, and was defined as the Charpy impact strength as a measure of toughness. The evaluation criteria for toughness were described below. Satisfying the evaluation criterion A was judged to be very high impact resistance, satisfying the evaluation criterion B was judged to be high impact resistance, and satisfying the evaluation criterion C was judged to be low impact resistance.
A: 2.0 kJ/m² or more
B: 1.0 kJ/m² or more and less than 2.0 kJ/m²
C: less than 1.0 kJ/m²

### (Dispersion Stability)

The dispersion stability of a photocurable resin composition was evaluated with LUMiSizer (manufactured by Rufuto). A photocurable resin composition was put in a polyamide cell with an optical path length of 10 mm to a height of 22 mm from the bottom face of the cell and was subjected to the measurement at 255 points under the conditions of a temperature of 25° C., a rotational speed of 4000 rpm, and a measurement interval of 30 seconds. The transmittance at each position is calculated by measuring the intensity of light passing through the cell at 0 mm to 25 mm from the bottom face of the cell and dividing the intensity by incident light intensity at each position. A plot of the transmittance at each position thus calculated is hereinafter referred to as a transmittance profile. In the transmittance profile at each time, to remove the influence of the shading of light due to the liquid surface and the cell bottom face, a region of 5 mm to 20 mm from the cell bottom face was set as a region of interest (ROI), and a separation boundary by sedimentation (or flotation) in the region was determined with a transmittance of 20% as a threshold. The distance that the separation boundary moved per unit time was calculated as the separation rate, and the separation rate was divided by relative centrifugal force to calculate the natural separation rate. When the separation boundary is not defined in the ROI in the measurement, the separation rate of the sample is defined as the “lower limit of measurement”. The evaluation criteria for the natural separation rate were described below. Satisfying the evaluation criterion A was judged to be very high dispersion stability, satisfying the evaluation criterion B was judged to be high dispersion stability, and satisfying the evaluation criterion C was judged to be low dispersion stability.
A: lower limit of measurement to less than 20 μm/day
B: 20 μm/day or more and less than 50 μm/day
C: 50 μm/day or more

TABLE 5

| | | | | | | | | | | | Comparative | | |
|---|---|---|---|---|---|---|---|---|---|---|---|---|---|
| | | | Exemplary embodiment | | | | | | | | example | | |
| | | | 1 | 2 | 3 | 4 | 5 | 6 | 7 | 8 | 1 | 2 | 3 |
| Resin | Polyfunctional radically | A-1-1 | 40 | 40 | 40 | 20 | — | — | 40 | 40 | 40 | 40 | 40 |
| composition | polymerizable compound | [parts by mass] | | | | | | | | | | | |
| | (A-1) | A-1-2 | — | — | — | — | 40 | 50 | | | — | — | — |
| | | [parts by mass] | | | | | | | | | | | |
| | | A-1-3 | 15 | 15 | 15 | 15 | 15 | — | 15 | 15 | 15 | 15 | 15 |
| | | [parts by mass] | | | | | | | | | | | |
| | | A-1-4 | 10 | 10 | 10 | 10 | 10 | — | 10 | 10 | 10 | 10 | 10 |
| | | (parts by mass] | | | | | | | | | | | |
| | | A-1-5 | — | — | — | 20 | — | — | — | — | — | — | — |
| | | [parts by mass] | | | | | | | | | | | |
| | Monofunctional radically | A-2-1 | 35 | 35 | 35 | 35 | 35 | 50 | 35 | 35 | 35 | 35 | 35 |
| | polymerizable compound | [parts by mass] | | | | | | | | | | | |
| | (A-2) | | | | | | | | | | | | |
| | Metallic soap (B) | B-1 | 2.5 | 7.5 | 2.5 | 2.5 | 2.5 | 2.5 | — | — | — | — | — |
| | | [parts by mass] | | | | | | | | | | | |
| | | B-2 | — | — | — | — | — | — | 2.5 | — | — | — | — |
| | | [parts by mass] | | | | | | | | | | | |
| | | B-3 | — | — | — | — | — | — | — | 2.5 | — | — | — |
| | | [parts by mass] | | | | | | | | | | | |
| | Other components | EX-1 | — | — | 2 | — | — | — | — | — | — | — | — |
| | | [parts by mass] | | | | | | | | | | | |
| | | EX-2 | — | — | — | — | — | — | — | — | — | 20 | — |
| | | [parts by mass] | | | | | | | | | | | |
| | | EX-3 | — | — | — | — | — | — | — | — | — | — | 20 |
| | | [parts by mass] | | | | | | | | | | | |
| | Curing agent (C) | C-1 | | 1 | 1 | 1 | 1 | 1 | 1 | 1 | 1 | 1 | 1 |
| | | [parts by mass] | | | | | | | | | | | |
| Evaluation | Diference in HSP value | Calculated value | 5.98 | 5.98 | 5.98 | 6.04 | 6.47 | 6.18 | 6.53 | 4.04 | — | — | — |
| | between radically polymerizable | [MPa^{1/2}] | | | | | | | | | | | |
| | component (A) and | | | | | | | | | | | | |
| | metallic soap (B) | | | | | | | | | | | | |
| | Ethylenically unsaturated group | Calculated value | 696 | 696 | 696 | 424 | 2095 | 2571 | 696 | 696 | 696 | 696 | 696 |
| | equivalent of radically | [g/eq] | | | | | | | | | | | |
| | polymerizable component (A) | | | | | | | | | | | | |
| | Formability | Rating | A | B | A | A | B | B | B | B | A | B | B |
| | Dispersion stability | Separation | Lower limit | Lower limit | Lower limit | Lower limit | Lower limit | Lower limit | Lower limit | Lower limit | — | 156 | 42 |
| | | speed [μm/day] | of measure- | of measure- | of measure- | of measure- | of measure- | of measure- | of measure- | of measure- | | | |
| | | | ment | ment | ment | ment | ment | ment | ment | ment | | | |
| | | Rating | A | A | A | A | A | A | A | A | — | C | B |
| | Friction coefficient | Measured value | 0.37 | 0.36 | 0.25 | 0.41 | 0.43 | 0.62 | 0.55 | 0.46 | 1.28 | 0.54 | 1.12 |
| | | Rating | A | A | A | A | A | B | B | A | C | B | C |
| | Specific wear rate | Measured value | 0.078 | 0.093 | 0.065 | 0.096 | 0.199 | 0.270 | 0.122 | 0.133 | 1.341 | 0.692 | 0.826 |
| | | [mm³ · N⁻¹·km⁻¹] | | | | | | | | | | | |
| | | Rating | A | A | A | A | A | A | A | A | C | B | B |
| | Charpy impact test | Measured value | 2.2 | 2.3 | 1.8 | 1.1 | 2.9 | 3.3 | 1.6 | 1.4 | 4.7 | 1.6 | 1.3 |
| | | [KJ/m²] | | | | | | | | | | | |
| | | Rating | A | A | A | B | A | A | B | B | A | B | B |

The polyfunctional radically polymerizable compound (A-1) content shown in Table 5 is expressed in parts by mass per 100 parts by mass of the polyfunctional radically polymerizable compound (A-1) and the monofunctional radically polymerizable compound (A-2) in total. Likewise, the monofunctional radically polymerizable compound (A-2) content is expressed in parts by mass per 100 parts by mass of the polyfunctional radically polymerizable compound (A-1) and the monofunctional radically polymerizable compound (A-2) in total. The metallic soap (B) content and the other components (EX-1 to EX-3) content are expressed in parts by mass per 100 parts by mass of the polyfunctional radically polymerizable compound (A-1) and the monofunctional radically polymerizable compound (A-2) in total. The curing agent (C) content is expressed in parts by mass per 100 parts by mass of the polyfunctional radically polymerizable compound (A-1), the monofunctional radically polymerizable compound (A-2), the metallic soap (B), the other components (EX-1 to EX-3) in total. The metallic soap (B) content and the curing agent (C) content shown in Table 6 is expressed in parts by mass per 100 parts by mass of the radically polymerizable component (A).

TABLE 6

| | | | | | | | | Comparative | | |
|---|---|---|---|---|---|---|---|---|---|---|
| | | | Exemplary embodiment | | | | | example | | |
| | | | 9 | 10 | 11 | 12 | 13 | 4 | 5 | 6 |
| Resin | Polyfunctional | A-1-3 | 20 | — | 80 | — | — | — | — | — |
| composition | radically | [parts by mass] | | | | | | | | |
| | polymerizable | A-1-4 | — | 20 | — | 80 | 95 | 50 | 50 | 20 |
| | compound (A-1) | [parts by mass] | | | | | | | | |
| | Monofunctional | A-2-1 | 80 | 80 | 20 | 20 | 5 | | | |
| | radically | [parts by mass] | | | | | | | | |
| | polymerizable | A-2-2 | — | — | — | — | — | 50 | — | — |
| | compound (A-2) | [parts by mass] | | | | | | | | |
| | | A-2-3 | — | — | — | — | — | — | 50 | — |
| | | [parts by mass] | | | | | | | | |
| | | A-2-4 | — | — | — | — | — | — | — | 80 |
| | | [parts by mass] | | | | | | | | |
| | Metallic soap (B) | B-1 | 2.5 | 2.5 | 2.5 | 2.5 | 2.5 | 2.5 | 2.5 | 2.5 |
| | | [parts by mass] | | | | | | | | |
| | Curing agent (C) | C-1 | 1 | 1 | 1 | 1 | 1 | 1 | 1 | 1 |
| | | [parts by mass] | | | | | | | | |
| Evaluation | Difference in HSP | Calculated | 6.35 | 6.37 | 7.09 | 7.20 | 7.63 | 8.21 | 8.32 | 8.66 |
| | value between | value [MPa^{1/2}] | | | | | | | | |
| | radically | | | | | | | | | |
| | polymerizable | | | | | | | | | |
| | component (A) and | | | | | | | | | |
| | metallic soap (B) | | | | | | | | | |
| | Dispersion stability | Separation | Lower limit | Lower limit | Lower limit | Lower limit | Lower limit | 218 | 561 | 946 |
| | | speed [μm/day] | of measure- | of measure- | of measure- | of measure- | of measure- | | | |
| | | | ment | ment | ment | ment | ment | | | |
| | | Rating | A | A | A | A | A | C | C | C |

The effectiveness of the present embodiment will be described below with reference to the exemplary embodiments and comparative examples using Tables 5 and 6.

### [Effectiveness of Metallic Soap (B)]

A comparison between Exemplary Embodiments 1 to 8 and Comparative Examples 1 to 3 shows that the systems containing the metallic soap (B) are rated B or higher in the evaluation of the dispersion stability, the friction coefficient, and the specific wear rate, thus achieving both high dispersion stability and high sliding characteristics (low friction coefficient and high wear resistance). By contrast, the systems without the metallic soap are rated C in the evaluation of the dispersion stability, the friction coefficient, or the specific wear rate and cannot have the same advantages as in the present embodiment.

[Effectiveness of Setting Difference in HSP Value between Radically Polymerizable Component (A) and Metallic Soap (B) to 0 MPa^{1/2} or More and 8.0 MPa^{1/2} or Less]

A comparison between Exemplary Embodiments 9 to 13 and Comparative Examples 4 to 6 shows that the metallic soap (B) has very high dispersion stability when the difference in HSP value between the radically polymerizable component (A) and the metallic soap (B) is 0 MPa^{1/2} or more and 8.0 MPa¹² or less. By contrast, it is shown that a difference in HSP value of more than 8.0 MPa^{1/2} results in insufficient dispersion stability.

Exemplary Embodiments 9 to 13 also had good results in terms of the friction coefficient, the specific wear rate, and the Charpy impact strength.

The present embodiment can form a three-dimensional object with good sliding characteristics and can provide a photocurable resin composition with high storage stability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-115656 filed Jul. 20, 2022 and No. 2023-069819 filed Apr. 21, 2023, which are hereby incorporated by reference herein in their entirety.

What is claimed is:

1. A photocurable resin composition, comprising a radically polymerizable component (A) and a curing agent (C), wherein the component (A) contains a polyfunctional radically polymerizable compound (A-1) and a monofunctional radically polymerizable compound (A-2),
wherein the photocurable resin composition further contains a metallic soap (B), and
a difference in HSP value between the component (A) and the component (B) is 0 MPa^{1/2} or more and 8.0 MPa^{1/2} or less.

2. The photocurable resin composition according to claim 1, wherein the radically polymerizable component (A) has an ethylenically unsaturated group equivalent of 500 g/eq or more and 2,500 g/eq or less.

3. The photocurable resin composition according to claim 1, wherein a metallic soap (B) content is 0.01 parts by mass or more and 15 parts by mass or less per 100 parts by mass of the radically polymerizable component (A).

4. The photocurable resin composition according to claim 1, wherein the metallic soap (B) has an average particle size of 50 μm or less.

5. The photocurable resin composition according to claim 4, wherein the metallic soap (B) has an average particle size of 4 μm or less.

6. The photocurable resin composition according to claim 1, wherein the metallic soap (B) is a compound composed of a saturated or unsaturated fatty acid with 12 or more carbon atoms and a metal ion.

7. The photocurable resin composition according to claim 6, wherein the saturated fatty acid is selected from the group consisting of lauric acid, myristic acid, pentadecylic acid, palmitic acid, margaric acid, stearic acid, 12-hydroxystearic acid, arachidic acid, behenic acid, lignoceric acid, montanic acid, and naphthenic acid, the unsaturated fatty acid is selected from the group consisting of oleic acid and ricinoleic acid; and the metal ion is selected from the group consisting of zinc, calcium, magnesium, aluminum, barium, lithium, sodium, and potassium.

8. The photocurable resin composition according to claim 6, wherein the saturated fatty acid is selected from the group consisting of lauric acid, stearic acid, 12-hydroxystearic acid, behenic acid, and montanic acid, and the metal ion is selected from the group consisting of zinc, calcium, magnesium, aluminum, barium, lithium, sodium, and potassium.

9. The photocurable resin composition according to claim 6, wherein the metallic soap (B) is zinc stearate.

10. The photocurable resin composition according to claim 1, wherein the monofunctional radically polymerizable compound (A-2) is selected from acrylamide compounds, (meth)acrylate compounds, maleimide compounds, and N-vinyl compounds.

11. The photocurable resin composition according to claim 1, wherein the polyfunctional radically polymerizable compound (A-1) is a (meth)acrylate compound or a urethane (meth)acrylate compound each having a polyether structure, a polyester structure, or a polycarbonate structure.

12. The photocurable resin composition according to claim 1, wherein a polyfunctional radically polymerizable compound (A-1) content is 20 parts by mass or more and 75 parts by mass or less per 100 parts by mass of the polyfunctional radically polymerizable compound (A-1) and the monofunctional radically polymerizable compound (A-2) in total.

13. The photocurable resin composition according to claim 1, further comprising a silicone oil.

14. A cured product produced by curing the photocurable resin composition according to claim 1.

15. A method for producing a three-dimensional object by an optical modeling method, comprising the steps of:
providing a photocurable resin composition in a layer form; and
applying light energy to the photocurable resin composition in the layer form based on slice data of a modeling model to cure the photocurable resin composition and form a modeling product,
wherein the photocurable resin composition is the photocurable resin composition according to claim 1.

16. The method for producing a three-dimensional object according to claim 15, wherein the light energy is light emitted from a laser source or a projector.
